(19) United States
(12) Patent Application Publication
(10) Pub. No.: US 2013/0297639 A1
(43) Pub. Date: Nov. 7, 2013

(54) GEOGRAPHIC COORDINATE TRANSLATION SYSTEM

(71) Applicants: Craig Bobik, Lutz, FL (US); Vanessa Rivera, Tampa, FL (US)

(72) Inventors: Craig Bobik, Lutz, FL (US); Vanessa Rivera, Tampa, FL (US)

(21) Appl. No.: 13/874,698

(22) Filed: May 1, 2013

Related U.S. Application Data
(60) Provisional application No. 61/642,375, filed on May 3, 2012.

(51) Int. Cl. G06F 17/30

(52) U.S. Cl. CPC G06F 17/30386
USPC 707/758

(57) ABSTRACT

A system for translating geographic coordinates into an easy to memorize word combination. The present invention may include a program implemented on a computer. The program directs the computer to translate inputted geographic coordinates into a word combination as well as translating the word combination back into the geographic coordinates. A user may use a mobile computing device to determine the coordinates of a location, the program may translate the coordinates to the word combination, and then the user may memorize the word combination displayed by the mobile computing device for later use.

### BACKGROUND OF THE INVENTION

The present invention relates to translating geographic coordinates and, more particularly, to translating the geographic coordinates into words.

The Global Positioning System (GPS) is a space-based satellite navigation system that provides location and time information in all weather conditions, anywhere on or near the Earth where there is an unobstructed line of sight to four or more GPS satellites. GPS devices may be used for recreational purposes. For example, if a user finds an ideal camping area, fishing area, hunting area or the like, a user may use the GPS device to figure out the coordinates of the location so that user may revisit the area. However, geographic coordinates are difficult to remember and a user does not always have access to paper and pencil.

As can be seen, there is a need for a system that facilitates easy memorization of the geographic coordinates.

### SUMMARY OF THE INVENTION

In one aspect of the present invention, a system for translating geographic coordinates, comprises: a computer having a user interface; and a program product comprising machine-readable program code for causing, when executed, the computer to perform the following process steps: determining the geographic coordinates for a location; translating the geographic coordinates into a word combination; and communicating the word combination to a user.

In another aspect of the present invention, a system for translating geographic coordinates, comprising: a computer having a user interface; and a program product comprising machine-readable program code for causing, when executed, the computer to perform the following process steps: prompting a user to input geographic coordinates of a location; translating the geographic coordinates into a word combination; and communicating the word combination to a user.

In another aspect of the present invention, a system for translating geographic coordinates, comprising: a computer having a user interface; and a program product comprising machine-readable program code for causing, when executed, the computer to perform the following process steps: providing an input, wherein a user inputs a word combination representing geographic coordinates; translating the word combination into geographic coordinates; and communicating the geographic coordinates to a user.

These and other features, aspects and advantages of the present invention will become better understood with reference to the following drawings, description and claims.

### BRIEF DESCRIPTION OF THE DRAWINGS

FIG. 1 is an overall schematic representation of the present invention;

FIG. 2 is a schematic view of the present invention demonstrating conversion of GPS coordinates to a word combination;

FIG. 3 is a schematic detail view of the present invention demonstrating conversion of GPS coordinates to a word combination; and

FIG. 4 is a schematic view of the present invention demonstrating a word combination conversion to graphical representation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for translating geographic coordinates into an easy to memorize word combination. The present invention may include a program implemented on a computer. The program directs the computer to translate inputted geographic coordinates into a word combination as well as translating the word combination back into the geographic coordinates. A user may use a computing device to determine the coordinates of a location, the program may translate the coordinates to the word combination, and then the user may memorize the word combination displayed by the mobile computing device for later use.

The present invention may include at least one computer with a user interface. The computer may include any computer including, but not limited to, a desktop, laptop, mobile Global Positioning System (GPS), and smart device, such as, a tablet and smart phone. The computer includes a program product including a machine-readable program code for causing, when executed, the computer to perform steps. The program product of the present invention may be part of a GPS software program, or may be a separate program. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a program and device that converts geographic coordinates into common and easy words to remember. For example, the device may convert the coordinates into four easy words to remember. The device of the present invention may display the coordinates in words, and then a user may type in those words into the device to find the desired location.

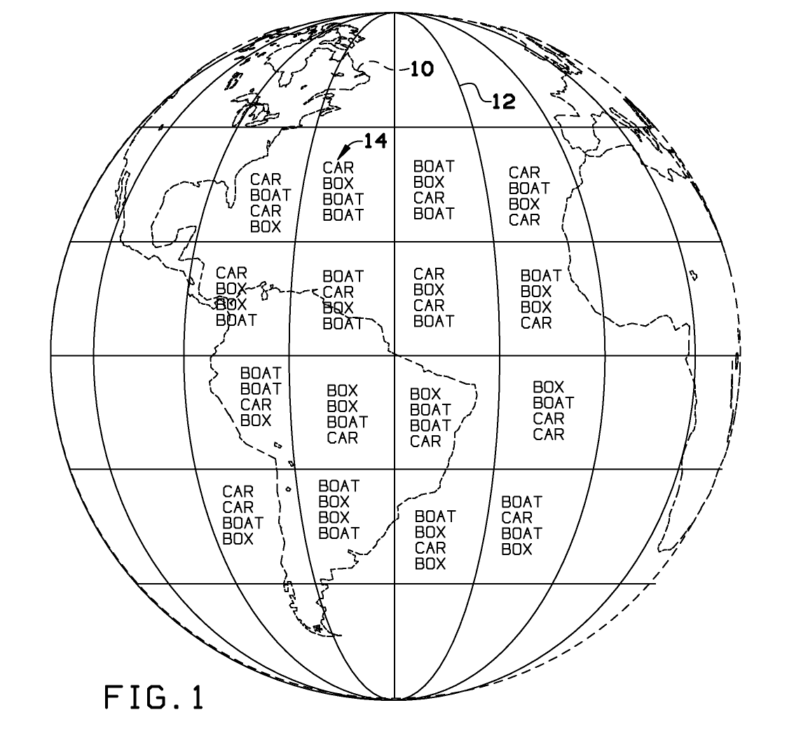

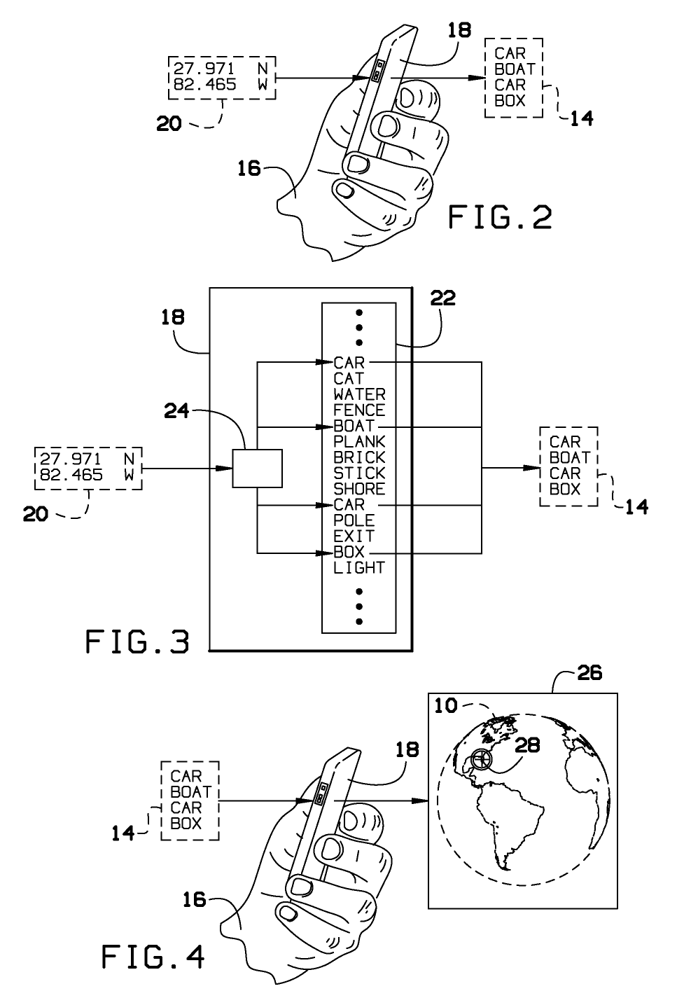

The following may comprise a method in which the words may be assigned. However, the present invention is not limited to the method described and the coordinates may be translated by any appropriate method known in the art. Referring to the FIG. 1, a map of the earth 10 is divided into trapezoids. Each trapezoid is defined by two longitude and two latitude lines creating a grid block 12. Each grid block 12 may be assigned four unique words from a list of common words. A computing device may convert coordinates into four words corresponding to the specific grid block 12 mentioned above.

The present invention may include a computing device 18 that may include a processor 24. A program product, such as software, may be read by and implemented by the computing device 18. The computing device 18, using the program product, may translate geographic coordinates 20 into a series of words 14, such as four simple words. The simple words may be easy for a user to remember.

In certain embodiments, an exemplary user may input a location into the computing device 18. The location may be in the form of an address, a numerical coordinate 20, or the like. The program product may convert the address to numerical coordinates 20 and/or convert the numerical coordinate 20 into a word combination 14. The computing device 18 may then display the word combination 14 to the exemplary user 16. The user may thereby remember the word combination 14 with ease.

As illustrated in FIG. 3, the present invention may include a database 22 that may include a word bank. Once the numerical coordinates 20 are inputted into the computing device 18, the processor 24 of the computing device 20, implemented by the program product, may use the database 22 to translate the numerical coordinates 20 into a word combination 14. The computing device 16 thereby translates the numerical coordinates 20 and assigns a word combination 22 to the special numerical coordinates 20 using the word bank in the database 22. The computing device 18 may then display the word combination 22 to a user. For example, as illustrated, the word combination 14 may be displayed as “car boat car box.” The computing device 18 may display the word combination 14 on a user interface, such as a device screen, may project the word combination 14 through speakers attached to the computing device 18, or a combination thereof.

As illustrated in FIG. 4, once a user 16 has translated numerical coordinates 20 into the word combination 22, the user may then input the word combination 22 into the computing device 16 to either translate the word combination 22 back to the numerical coordinates or to find the location target 28 using the word combination 14. If the user is using the word combination 22 to find the location target 28, the computing device 16 may include a GPS program. The location target 28 may be displayed on a geographic overlay 10. Further, the GPS program may provide directions to the location target 28 on the geographic overlay 10.

In certain embodiments, the user may input the word combination 14 into the computing device 18 using a keyboard, mouse, touch screen or a microphone. The program product may translate the word combination 14 to GPS coordinates 20 and may display the GPS coordinates to a user. Alternatively, the computing device 18 may implement a GPS program that uses the translated GPS coordinates 20 to locate the target 28 on the geographic overlay 10 and provide the user 16 with directions. The computing device 18 may display the directions on a user interface such as a display screen, may project the directions through speakers attached to the computing device 18, or a combination thereof.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for translating geographic coordinates, comprising:
a computer having a user interface; and
a program product comprising machine-readable program code for causing, when executed, the computer to perform the following process steps:
determining the geographic coordinates for a location;
translating the geographic coordinates into a word combination; and
communicating the word combination to a user.

2. The system of claim 1, wherein the program product further causes the machine to prompt a user to input the location.

3. The system of claim 1, wherein communicating the word combination to a user comprises using at least one of a speaker and a screen display connected to the computer.

4. The system of claim 1, wherein the word combination comprises four words.

5. The system of claim 1, further comprising a word database saved onto a memory of the computer, wherein the program product uses the word database to translate the global position system coordinates into the word combination.

6. A system for translating geographic coordinates, comprising:
a computer having a user interface; and
a program product comprising machine-readable program code for causing, when executed, the computer to perform the following process steps:
prompting a user to input geographic coordinates of a location;
translating the geographic coordinates into a word combination; and
communicating the word combination to a user.

7. The system of claim 6, wherein communicating the word combination to a user comprises using at least one of a speaker and a screen display connected to the computer.

8. The system of claim 6, wherein the word combination comprises four words.

9. The system of claim 6, further comprising a word database saved onto a memory of the computer, wherein the program product uses the word database to translate the geographic coordinates into the word combination.

10. A system for translating geographic coordinates, comprising:
a computer having a user interface; and
a program product comprising machine-readable program code for causing, when executed, the computer to perform the following process steps:
providing an input, wherein a user inputs a word combination representing geographic coordinates;
translating the word combination into geographic coordinates; and
communicating the geographic coordinates to a user.

11. The system of claim 10, wherein communicating the word combination to a user comprises using at least one of a speaker and a screen display connected to the computer.

12. The system of claim 10, wherein the word combination comprises four words.

13. The system of claim 10, further comprising a word database saved onto a memory of the computer, wherein the program product uses the word database to translate the geographic coordinates into the word combination.

14. The system of claim 10, wherein the program product further comprises a global positioning system.

15. The system of claim 14, wherein the program product further causes the machine to provide directions to a location based on the translated geographic coordinates.
